(19) United States
(12) Patent Application Publication
(10) Pub. No.: US 2003/0058271 A1
(43) Pub. Date: Mar. 27, 2003

(54) Method and system and article of manufacture for internet slide show

(75) Inventor: Pieter Van Der Meulen, Sunnyvale, CA (US)

Correspondence Address: Corporate Patent Counsel, Philips Electronics North America Corporation, 500 White Plains Road, Tarrytown, NY, 10591, US

(73) Assignee: KONINKLIJKE PHILIPS ELECTRONICS N.V.

(21) Appl. No.: 09/967,254

(22) Filed: Sep. 27, 2001

(51) Int. Cl. G09G 5/00

(52) U.S. Cl. 345/738

(57) ABSTRACT

The present invention comprises a system and method related to the field of sequentially displaying content contained in a series of datasets. In an exemplary embodiment, a system according to the present invention comprises an Internet browser executing in a presentation device, at least one portion of the Internet browser being adapted to interpret meta-tags; a plurality of memory regions, each memory region corresponding to one of a plurality of frames for display on the presentation device, each frame being selectively enabled with at least one frame being a selectively hidden frame; a plurality of datasets, each dataset comprising data processable for presentation; and software executing at the source, capable of generating one or more formatted page files, each page file processable by the Internet browser, each page file comprising Internet browser directives comprising a dataset identifier, a content data file associated with the dataset, at least one refresh meta-tag to instruct the Internet browser to download a predetermined next dataset of the plurality of datasets for presentation; and at least one refresh meta-tag containing a timing value.

### BACKGROUND OF THE INVENTION

1. Field of the Invention

The present invention relates to the field of sequentially displaying content contained in a series of datasets. More specifically, the present invention, in an exemplary embodiment, relates to using an Internet browser to present content such as images in a slide show from datasets obtained from a server such as an Internet server.

2. Description of the Related Art

It is often desirable to obtain a plurality of datasets from one or more sources of datasets for presentation in a sequence such as for viewing or other manipulation. By way of example and not limitation, digital photography has created a need for systems and methods to display digital photographs in configurable ways. For example, U.S. patent application Ser. No. 09/993,586 (Attorney docket US00023 1) filed Aug. 18, 2000 for Adler (“Adler '585”), incorporated by reference in full herein, discloses a stand-alone monitor as photograph show projector that teaches a standalone monitor capable of displaying one or more digital photograph images where the images are periodically displayed or displayed on demand from a user input such as from a keypad.

U.S. Pat. No. 6,121,970 to Guedalia discloses a method for archiving digital data such as photographs on a server and using an HTML page and a browser to enable a user to interactively view a digital image derived from the digital data. Guedalia '970 teaches using an HTML page that includes a view window within which a first image is displayed where the view window is partitioned into a plurality of imaginary sub-regions. The user selects at least one region of the view window to indicate which new HTML page is desired, generating a new HTML page with a link to a second image.

One problem with approaches such as these is that a sequenced display of a number of images such as a slide show or presentation has a noticeable, visible latency between presentation of different datasets.

Other methods for presenting sequenced datasets exist. For example, U.S. Pat. No. 6,211,974 to Haneda discloses a dedicated system for, among other items, film image management. Haneda '974 teaches a slide-show program comprising information indicating a playback sequence, information relating to combinations of film images and video components, and information for controlling the generation of sound is created in a playback apparatus and recorded on a user's disk. As with similar prior art methods, Haneda '974 discloses a dedicated, proprietary system.

U.S. Pat. No. 6,029,175 to Chow, et al., discloses a method of automatic retrieval of changed files using a network agent. In part, Chow '175 teaches detecting occurrence of changes in objects of interest, and in response to detecting the occurrence of a change in an object of interest, determining whether an update notification would then be desirable for each interested party in the list of interested parties interested in the object of interest in which the occurrence of change is detected. However, slide show or presentation materials may not change during a time frame in which it is desired to display differing datasets.

None of the prior art teaches or suggests using hidden HTML or XML tags such as meta-tags to convey information to a browser such as a time-to-change or time-between-slides timing value. None of the prior art teaches or suggests using hidden tags such as meta-tags to further convey information to a browser such as a next-in-sequence value. Further, none of the prior art teaches or suggests having server-based software scan data files for presentment and automatically create Internet browser processable files to sequentially present those data files.

### BRIEF DESCRIPTION OF THE DRAWINGS

These and other features, aspects, and advantages of the present invention will become more fully apparent from the following description, appended claims, and accompanying drawings in which:

FIG. 1 is a schematic of an exemplary system configuration of the present invention;

FIG. 2 is a representation of a dataset with a REFRESH meta-tag of the present invention;

FIG. 3 is a representation of a plurality of Internet browser frames and a presentation device;

FIG. 4 is a flowchart demonstrating a process flow of an exemplary embodiment of the present invention;

FIG. 5a is an exemplary representation of a presentation screen showing conditional branching; and

FIG. 5b is a schematic representation of the presentation screen of FIG. 5a.

### DETAILED DESCRIPTION OF THE PREFERRED EMBODIMENT

In general, throughout this description, if an item is described as implemented in software, it can equally well be implemented as hardware.

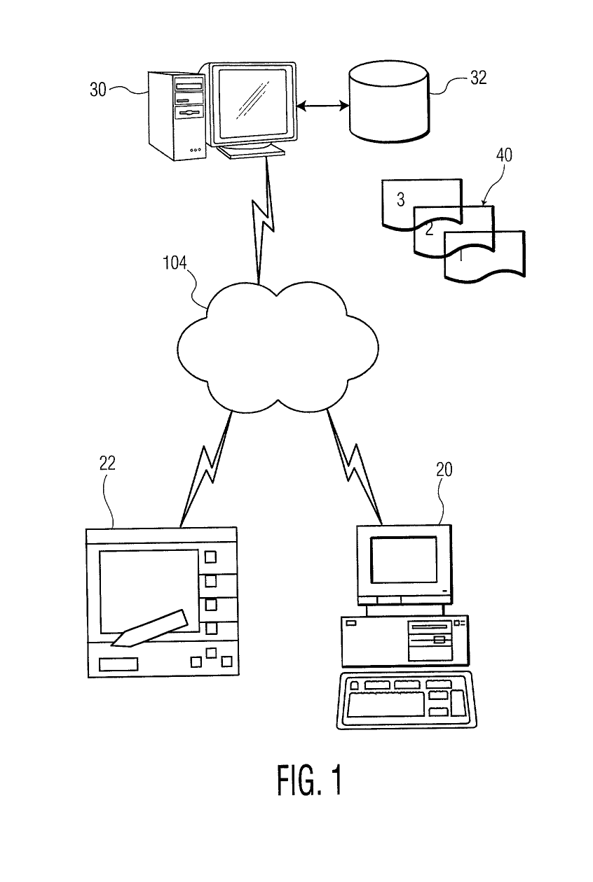

Referring now to FIG. 1, a plurality of datasets 40 are stored on server 30. As used herein, “server” can a device such as server 30 located somewhere on a wide area network such as the Internet 104 or a device local to and/or accessible locally to presentation device 20 such as via a local area network (not shown in the figures), or the like, or a combination of the above. As further used herein, “dataset 40” comprises data files comprising content such as digital photographs, HTML files, XML files, audio files such as audio data stream or MP3 files, video files, text files, and the like, or any combination thereof such that each dataset 40 comprises a series of data suitable for manipulation and/or presentation. Each dataset 40 further comprises a formatted file processable by an Internet browser such as an HTML file which contains directives regarding timing, identifiers, and links to data files. As used herein below, “data file” is understood to comprise the above dataset 40 data. By way of example and not limitation, a dataset 40 may additionally comprise graphic files such as photographs or graphic files where some of the graphic files have associated audio files containing sound annotations such as a photograph coupled with a greeting of a person in or associated with the photograph. As further used herein, “HTML” and “XML” are interchangeable.

As further used herein, a “presentation device” such as presentation device 20 is a device capable of rendering data in a dataset 40 into human perceptible formats such as visual and/or auditory forms. As further used herein, “presentment” means processing and presenting data into a human perceptible formats such as visual and/or auditory forms.

Presentation device 20 is operatively connected to server 30. Presentation device 20 can be a personal computer 20; a personal digital assistant 22, such as a Palm™ manufactured by Palm Inc. of Santa Clara, Calif.; a standalone monitor (not shown in FIG. 1); an Internet enabled phone (not shown in FIG. 1); an Internet web device, such as the Net Display Module from Philips Components of Eindhoven, The Netherlands (not shown in FIG. 1);or the like or any combination thereof. Presentation device 20 is capable of receiving one or more datasets 40 and manipulating data in the datasets 40, including displaying visual data in the dataset 40 and reproducing audio data that is part of the dataset 40.

Additionally, software executing in server 30 is capable of detecting data files capable of presentment at presentation device 20 and automatically creating one or more Internet browser processable files such as, by way of example and not limitation, HTML files that contain directives that allow the Internet browser to sequentially present the data files.

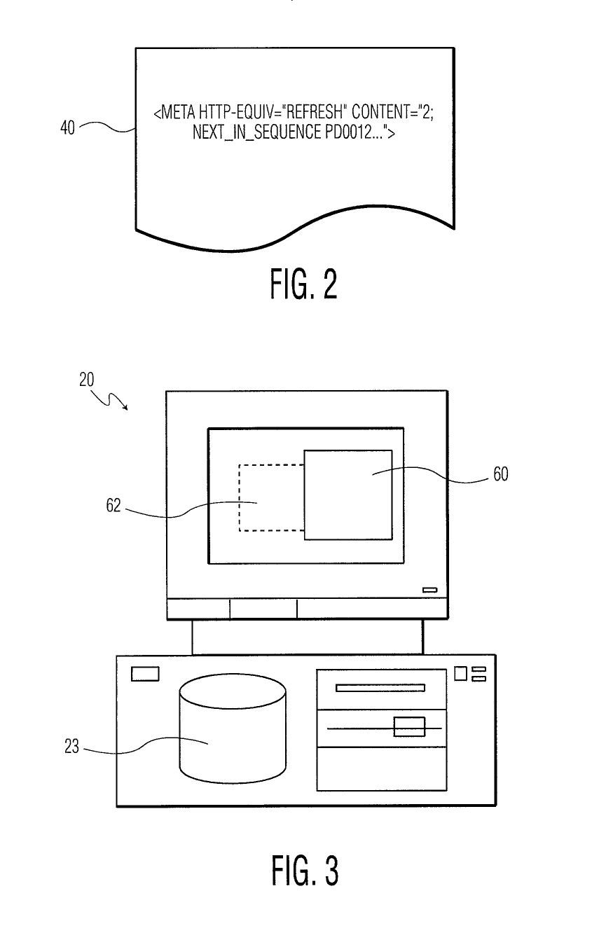

Referring now to FIG. 2, meta-tags 52 are well known to those of ordinary skill in the HTML and XML software arts and can be put to numerous uses, by way of example and not limitation including identifying the creator of the page, defining what HTML specifications the page follows, keywords and descriptions of the page, and a refresh parameter which can be used to cause the page to reload itself or to load another page. For example, see http://btml.about.com/library/weekly/aa080300a.htm, “META TAG REFRESH” by Jennifer Kyrnin. Most Internet browsers support REFRESH meta-tags 52. Accordingly, in the preferred embodiment each dataset 40 may be formatted as an HTML document with the timing value and sequencing values being part of am embedded REFRESH meta-tag 52. In a preferred embodiment, each dataset 40 may comprise a plurality of timing values and sequencing values encapsulated in a REFRESH meta-tag 52.

In a preferred embodiment, each dataset 40 also has a unique identifier, although currently envisioned alternative embodiments allow for groupings of datasets 40 sharing an identifier such as would be useful in random presentation of information.

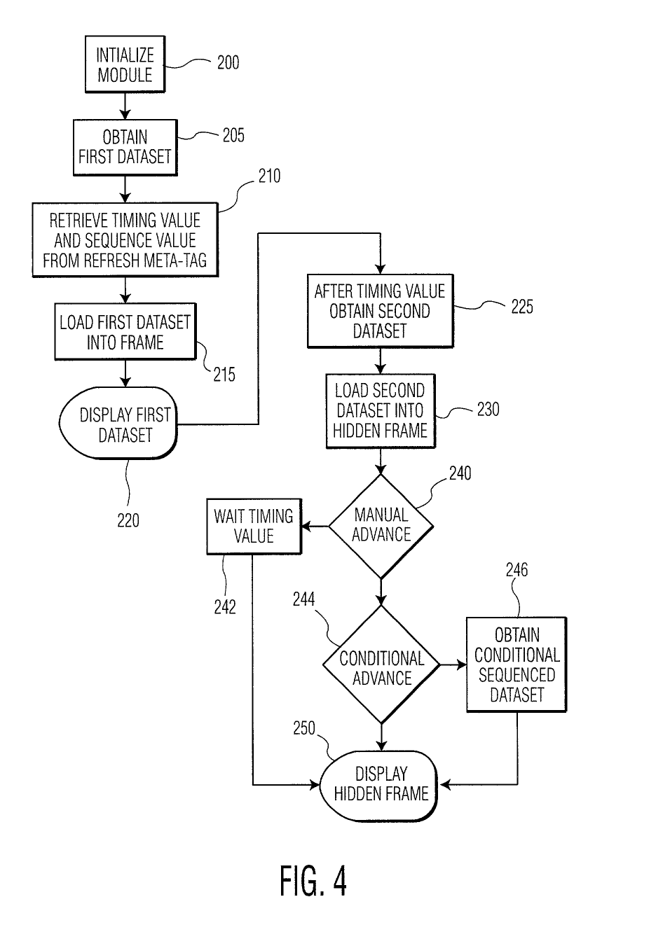

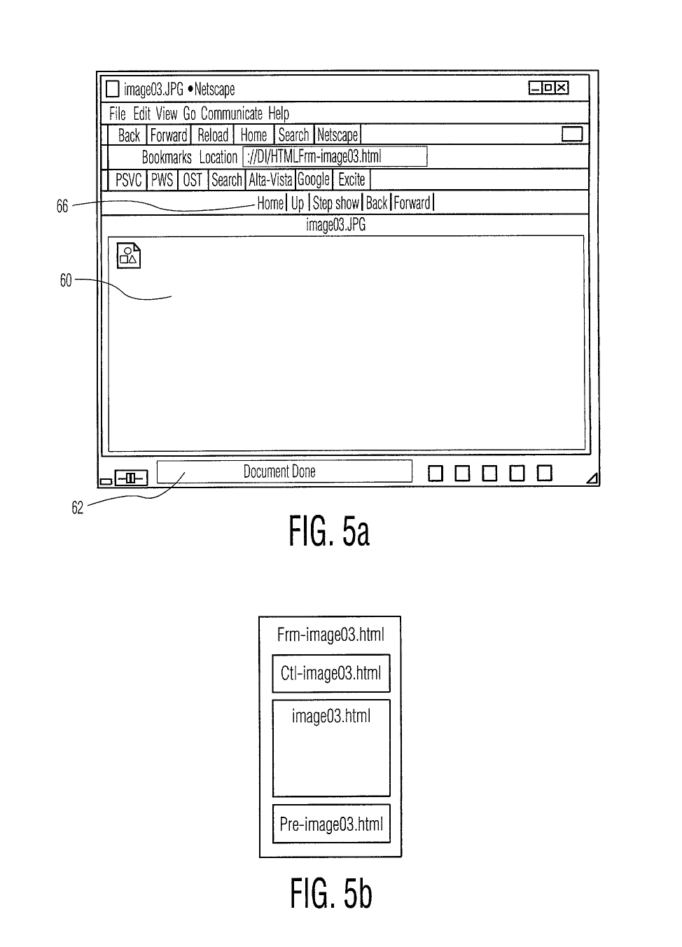

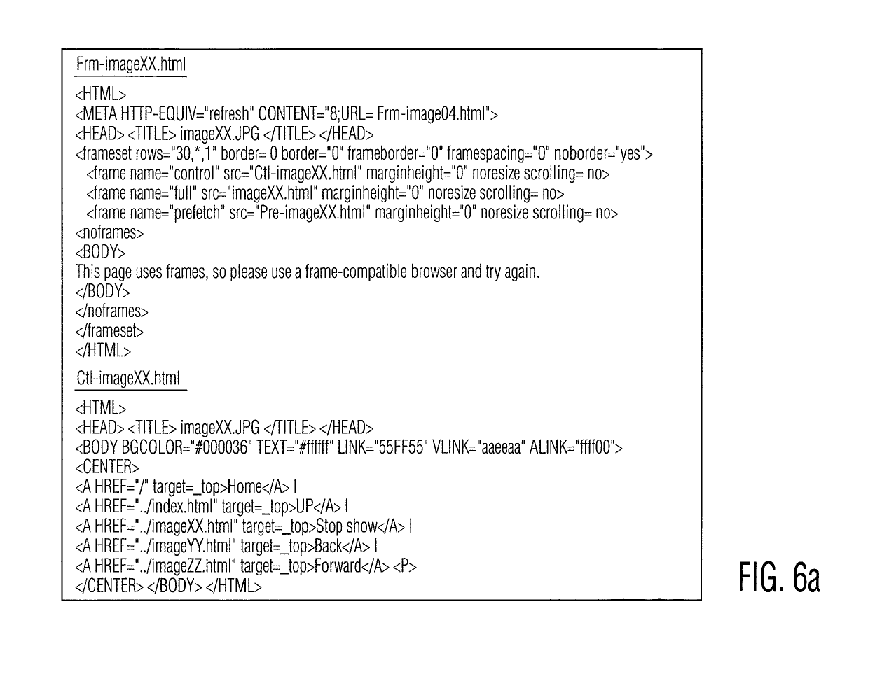

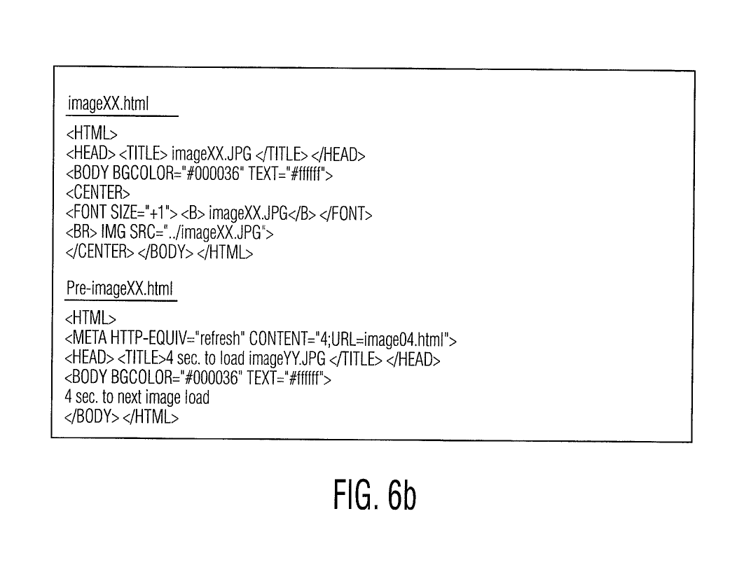

In the operation of an exemplary embodiment, referring now to FIG. 3, FIG. 4, FIG. 5a, and FIG. 5b, an Internet browser at presentation device 20 that has loaded an HTML or XML page 50 according to the present invention is triggered by a REFRESH meta-tag 52 in that page 50 to load a next dataset 40 as well as to hide or unhide a predetermined frame containing data to be presented. Because HTML or XML page 50 contains directives native to an Internet browser such as REFRESH meta-tags 52 and frames 60,62,64,66 the present invention does not require downloading of program data along with the data to be presented such as would be the case with JAVA® or programmatically scripted languages. In the currently preferred embodiment, an Internet browser, once triggered, determines if the data received from server 30 in a new dataset 40 contains a REFRESH meta-tag 52. If it does, the Internet browser examines the REFRESH meta-tag 52 in the new dataset 40, and if the new REFRESH meta-tag 52 contains one or more timing values and sequencing values, the Internet browser downloads or otherwise obtains a new dataset 40 as specified in the sequencing value.

In prior art techniques using JAVA® or JAVASCRIPT™, pre-loading and decoding a next image into a hidden buffer is well known. However, in the prior art, Internet browsers may allow users to enable or disable scripting features or even entire programming languages such as JAVA®. Users who disable JAVA® or JAVASCRIPT™ also prevent, perhaps unknowingly, any alternative slide show program written in JAVA® or JAVASCRIPT™ from executing or even showing the first slide. Further, the JAVA® or JAVASCRIPT™ prior art requires program data to be transferred along with the presentation data, leading to slower initiation of the slide show.

Referring still to FIG. 3, datasets 40 may be first retrieved such as from server 30 or data store 23 into working memory such as RAM to be processed into a first frame 60 for presentation. As used herein, data store 23 may be co-located with computer 20 or with server 30. While first frame 60 is accessible, such as by being visible and/or audible, a second dataset 40 may be retrieved from server 30 or data store 23 into working memory such as RAM to be processed into second frame 62. In a preferred embodiment, data being downloaded are typically of a size that allows the download to be accomplished in a time period shorter that the time period required to present the data, e.g. to show the picture or listen to the sounds. However, second frame 62 remains hidden, such as by being invisible and/or inaudible. Browser frames 60, 62, 64, 66 may be hidden using any one of alternative techniques as will be familiar to those of ordinary skill in the Internet browser software arts.

As further used herein, data store 23 may comprise optical storage media such as DVD-R/W or CD-R/W, and removable/fixed magnetic storage medium such as floppy or hard disk media. Data store 23 may further comprise a self-contained slide-show presentation that does not require the presence of an Internet server. By way of example and not limitation, most Internet browsers use “file:” protocol rather than an “http:” protocol to allow locally stored HTML pages to run the slide show. Creation of locally stored datasets 40 may be accomplished by viewing software executing as a user initiated or automatically initiated program running on a local computer, e.g. local PC or workstation 20, as opposed to on server 30.

Second frame 62 may be unhidden or expanded automatically after a period of time specified in the REFRESH meta-tag 52. As used herein, a “hidden” frame may still be at least barely visible, e.g. at the bottom of the display. Upon making second frame 62 unhidden, first frame 60 is made hidden, such as by being rendered invisible and/or inaudible. When the time period specified by the timing value of the REFRESH meta-tag 52 in the first dataset 40 has elapsed, the Internet browser switches to hidden frame 62, by way of example and not limitation by making frame 60 with the first dataset 40 hidden and making hidden frame 62 with its second dataset 40 contents visible. This method reduces if not eliminates a noticeable lag or wipe effect that often occurs when switching between a currently displayed dataset 40 and a new dataset 40.

In a preferred embodiment, a user may initiate a slide show using the present invention by downloading or dragging and dropping data files into a predetermined folder, as that term is understood by those of ordinary skill in the software arts, on server 30 or on data store 23. The data files, by way of example and not limitation, may be formatted in a visually oriented format such as a JPEG format. In the preferred embodiment, the folder is accessible to server 30 and is monitored by software resident at server 30 at predetermined times.

In a preferred embodiment, if the server software does not find HTML files in the folder, the server software generates HTML files for the each of the data files in the folder for which the server software can generate HTML files, by way of example and not limitation JPEG files. By way of example and not limitation, a portion of the software of the present invention, in the preferred embodiment executing on server 30, generates an appropriate HTML file, typically named “index.html” or “index.htm,” such as by using a batch program on server 30 to generate required one or more HTML files that do not already exist. The generated HTML file comprises an overview of appropriate data files in the target folder and may further comprise a contact sheet for each such data file. Accordingly, the HTML file will comprise a reference to all image files in the folder.

Software executing on server 30 may also generate frame files 50 for each appropriate data file in the folder. The generated HTML files contain sufficient REFRESH meta-tags 52 and other encoding to accomplish a sequential presentation of the data files in the folder. Accordingly, users who connect to a slide show server such as server 30 using an Internet browser will be able to obtain a slide-show presentation via server-generated HTML pages, using REFRESH meta-tags 52 and frames 60,62,64, as opposed to only seeing selected files such as picture files.

In a currently preferred embodiment, the Internet browser also causes hidden frame 62 to load a third empty frame 64 with a predetermined value for REFRESH meta-tag 52 which may vary between one to ten seconds and which typically has a value of around four seconds in the preferred embodiment. This lessens having both the currently presented dataset 40 and the next dataset 40 being downloaded simultaneously.

The time of downloading of the first data file and the initially hidden next data file is an important aspect of the preferred embodiment of the present invention. In the preferred embodiment, hidden frame 62 is initially empty, i.e. it contains no data. However, hidden frame 62 does contain a directive to start the download of data into second hidden frame 64 in a predetermined amount of time, by way of example and not limitation a matter of seconds such as four seconds. Second hidden frame 64 will then contain data after the predetermined amount of time. In this manner, downloading of the data is staggered in time.

By way of example and not limitation, the method of the present invention may be contrasted to an alternative method that does not use second hidden frame 64. Typically, Internet a browsers can send up to five requests at the same time to server 30. Referring now to FIG. 5a and FIG. 5b, assume that an Internet browser is asked to start a slide show and download a first picture into a large center frame such as frame 60. Since there is nothing in a buffer associated with a hidden a frame such as frame 62, the download starts slowly and exhibits a wipe action familiar in the prior art, e.g. from top to bottom. If hidden frame 62 includes a reference to the next picture, the Internet browser also initiates this download, practically at the same time. As a result, a user sees the first picture download slowly because the first and the next images are downloading at the same time. After the first dataset, this behavior is not nearly as pronounced since no two images will download anymore at the same time. Minor stalls in displaying may still happen, in part because data for the next HTML-frame are still needed and may interfere with the download of the next picture data.

In this manner, by way of example and not limitation, a first dataset 40 with frames 60,62,66 may be downloaded into the browser. First hidden frame 62 refreshes after a four second period into second hidden frame 64 with image data of the next dataset 40. After another four seconds, the whole dataset 40 is refreshed by the original, e.g. a total of eight seconds for a slide refresh meta-tag 52. In this example, each dataset 40 would therefore be visible for a total of eight seconds.

In this manner, by way of example and not limitation, a first dataset 40 may be downloaded into hidden frame 62. A second hidden frame 64 is also initialized with an empty dataset 40. Second hidden frame 64 refreshes after a four second period. First hidden frame 62 is activated, and a new dataset 40 then loaded into second hidden frame 64. After another four seconds, second hidden frame 64 is activated and the process begins again. In this example, each dataset 40 would be visible for a total of eight seconds.

As it is sometimes advantageous to allow an Internet browser user to make a conditional decision, server software or users may generate HTML files according to the present invention that allow for conditional branching. Thus, an HTML file 50 may also contain sequencing values such as in the REFRESH meta-tag 52 that further contain a plurality of sequence values comprising dataset 40 identifiers. The dataset 40 to be selected next for presentation would be conditioned on a user's response to a conditional query. Referring now to FIG. 5a, conditional frame navigation may be accomplished such as by use of icons (not shown in the figures), menus 66, or the like, or a combination thereof, as will be familiar to those of ordinary skill in the HTML or XML software arts. As used herein, the “menu” is provided in a frame, frame 66.

Using the method and dataset 40 structure of the present invention, Internet and/or locally based sequences of advertisements, mixed media, photographs such as personal photographs, or the like, or a combination thereof may be accessed from presentation device 20 using an Internet browser. After the initial load, the desired sequenced series of images, audio, and other data will be presented in a predetermined sequence having a predetermined latency time between new datasets 40.

Referring now to FIG. 5a, FIG. 5b, FIG. 6a, and FIG. 6b, exemplary server-side HTML scripting code is shown for four HTML files related to the present invention's sequential data presentation method: Frm-imageXX.html, shown generally at 80; Ctl-imageXX.html, shown generally at 82; ImageXX.html, shown generally at 84; and Pre-imageXX.html, shown generally at 86. Typically, these files are relatively small in size. Frm-imageXX.html 80 is a “holder” frame which refers to the other three HTML files which comprise content: Ctl-imageXX.html 82, ImageXX.html 84, and Pre-imageXX.html 86. By way of example and not limitation, if there are ten pictures in a presentation such as a slideshow, server 30 or a user generates ten sets of four HTML pages to be included in the attachment, i.e. forty in total. The small size of each file leads to an efficient, compact use of bandwidth.

Frm-imageXX.html 80 defines the holder frame and may be seen to have required a border around the other three frames, although the border width may be set to zero. Frm-imageXX.html 80 also defines the visual slide refresh time. The other three frames may be considered sub-windows displayed within Frm-imageXX.html 80. Of the 3 sub-windows, Pre-imageXX.html 86 relates to and defines hidden frame 62. In the example shown, Pre-imageXX.html 86 is defined as a one pixel high frame (see 801 in FIG. 6a: frameset rows=“30,*,1” means 30 pixels high for Ctl-imageXX.html, 1 for Pre-imageXX.html, and the rest for imageXX.html which holds the data image). After four seconds a user may perceive, however slightly, Pre-imageXX.html 86 refreshing into the contents of imageYY.html, a dataset 40. After another four seconds, the whole frame refreshes to present data from Frm-imageYY.html with data from imageYY.html now showing immediately and for the next eight seconds. After a further four seconds, Pre-imageYY.html refreshes itself almost invisibly to present data from imageZZ.html. The process repeats for each appropriate data file in the folder for which an index has been generated.

By way of further example, FIG. 5a, FIG. 6a, and FIG. 6b demonstrate branching. In this example, branching is available to the user at any time via a control sequence, shown as menu 66. The page defined by Ctl-imageXX.html appears at the top of frame page 60 defined by Frm-imageXX.html. If the user clicks on any of the links in the control page, e.g. “Back,” the current slide show stops and the user gets another set of HTML pages. In this manner, a user can navigate the sequential presentation of data in a manual advance mode.

As described above, in a preferred embodiment each of the appropriate data files in the folder on server 30 also has at least one HTML file associated just with itself in order to allow sequential presentations and navigation such as shown the top-frame in FIG. 5a. In a preferred embodiment, if a data file is missing from the index file, e.g. because the data files were added on later, server software would need to execute run even if there is an index.html. In this manner, the server software runs if it does not find the appropriate HTML files for each picture or if it finds that the index page (e.g. index.html) is missing.

By way of further example and not limitation, this method may be used to display a series of datasets 40 such as from a kiosk or to a captive audience such as in an elevator.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An improved system for presenting a sequential series of data using an Internet browser, comprising:
a. a presentation device further comprising a plurality of memory regions, each memory region corresponding to one of a plurality of frames for display on the presentation device, each frame being selectively enabled with at least one frame being a selectively hidden frame;
b. an Internet browser executing in the presentation device, at least one portion of the Internet browser being adapted to interpret meta-tags;
c. a plurality of datasets, each dataset comprising data processable for presentation; and
d. software executing at the source and capable of generating one or more page files formatted for processing by the Internet browser, each page file comprising Internet browser directives comprising a dataset identifier, an identifier of a content data file associated with the dataset, at least one refresh meta-tag to instruct the Internet browser to download a predetermined next dataset of the plurality of datasets for presentation, and at least one refresh meta-tag containing a timing value.

2. The system of claim 1 wherein the presentation device comprises personal computers, personal digital assistants, Internet enabled telephones, and Internet enabled handheld tablets.

3. The system of claim 1 wherein the datasets comprise digital photographs data, HTML files, XML files, audio data comprising MP3 data, video data, text data, mixed data files comprising graphics and audio data, and combinations thereof.

4. The system of claim 1 wherein each dataset identifier is a unique identifier.

5. The system of claim 1 wherein the timing value comprises a plurality of timing values comprising timing value definitions of when to retrieve a next dataset, when to display the next dataset, and how long to display a currently displayed dataset.

6. The system of claim 1 wherein the source of the plurality of datasets is an online service, further comprising a data communications interface operatively connected to the presentation device and the online service.

7. The system of claim 6 wherein the data communications interface provides access to the online service via the Internet.

8. The system of claim 6 wherein the online service provides the plurality of data sets using push technology.

9. The system of claim 1 wherein only one frame is enabled for presentment at a time.

10. A method for presentation of data contained in a plurality of datasets in a predetermined sequence using an Internet browser, each dataset having a dataset identifier, comprising:
a. obtaining a first dataset, the first dataset comprising a refresh meta-tag, the refresh meta-tag further comprising at least one timing value and at least one dataset sequence value;
b. storing the first dataset into a memory region associated with a first Internet browser frame presentable on a presentation device;
c. enabling presentment of data from the first dataset in the first Internet browser frame on a presentation device;
d. while data from the first dataset are being presented, obtaining a second dataset, the second dataset comprising a refresh meta-tag, the refresh meta-tag further comprising at least one timing value and at least one dataset sequence value;
e. storing the second dataset in a memory location associated with a second Internet browser frame presentable on a presentation device, the second Internet browser frame initially being a hidden frame;
f. disabling presentment in at least a portion of the Internet browser second frame on the presentation device; and
g. after the predetermined timing value from the first dataset has elapsed,
i. revealing the hidden Internet browser second frame;
ii. enabling presentment of data from the second dataset in the Internet browser second frame;
iii. hiding the first Internet browser frame; and
iv. disabling presentment of at least a portion of the data in the first Internet browser frame on the presentation device.

11. The method of claim 10 further comprising:
h. obtaining a next dataset using the at least one dataset sequence value from the first dataset; and
i. repeating step (b) through step (g).

12. The method of claim 10 wherein hidden Internet browser frames are completely removed from view on the presentation device.

13. The method of claim 10 wherein step (g) further comprises:
i. maximizing a first Internet browser frame in which data from the first dataset are being presented;
ii. processing data from the stored second dataset into a second Internet browser frame, while data from the first dataset are still being presented, the second frame being hidden;
iii. hiding the first frame after a predetermined timing value from the first dataset has elapsed; and
iv. revealing the second frame after a predetermined timing value from the first dataset has elapsed.

14. The method of claim 12 further comprising:
f. for the first dataset, the first dataset comprising a plurality of dataset sequence values, obtaining input from a user as to which of a plurality of dataset choices the user desires, the dataset choices being related to the plurality of dataset sequence values;
g. obtaining a next dataset using a selected dataset choice; and
h. repeating step (b) through step (g).

15. A method for presentation of data contained in a plurality of datasets in a predetermined sequence using an Internet browser, each dataset having a dataset identifier, comprising:
a. scanning data files stored in a predetermined portion of a data store for data files comprising content for presentment by the Internet browser;
b. for each such data file, creating an Internet browser processable file comprising a link to the data file, the Internet browser processable file comprising a refresh meta-tag, the refresh meta-tag further comprising at least one timing value and at least one dataset sequence value;
c. retrieving a first Internet browser processable file at a presentation device using the Internet browser; and
d. processing the Internet browser processable file, comprising:
i. storing data defined by a first Internet browser processable file into a memory region associated with a first Internet browser frame presentable on the presentation device;
ii. enabling presentment of the data from the first Internet browser processable file in the first Internet browser frame on a presentation device;
iii. while data from the first Internet browser processable file are being presented, obtaining a second Internet browser processable file defined in the first Internet browser processable file into a memory region associated with a second Internet browser frame presentable on the presentation device, the second Internet browser frame initially being a hidden frame;
iv. creating a third Internet browser frame that is hidden, the third Internet browser frame containing no data;
v. hiding the first Internet browser frame and revealing the second Internet browser frame after the predetermined timing value from the first Internet browser processable file has elapsed;
vi. while data from the second Internet browser processable file are being presented, obtaining data from a third Internet browser processable file defined in the second Internet browser processable file into a memory region associated with the third Internet browser frame; and
vii. hiding the second Internet browser frame and revealing the third Internet browser frame after the predetermined timing value from the second Internet browser processable file has elapsed.

16. An improved system for presenting a sequential series of data using viewing software, comprising:
a. a presentation device further comprising a plurality of memory regions, each memory region corresponding to one of a plurality of frames for display on the presentation device, each frame being selectively enabled with at least one frame being a selectively hidden frame;
b. a plurality of datasets, each dataset comprising data processable for presentation;
c. viewing software executing in the presentation device, at least one portion of the viewing software being adapted to interpret meta-tags, the viewing software capable of rendering the presentation data into a human perceptible form; and
d. software executing at the source and capable of generating one or more page files formatted for processing by the viewing software, each page file comprising viewing software directives comprising a dataset identifier, an identifier of a content data file associated with the dataset, at least one refresh meta-tag to instruct the viewing software to retrieve a predetermined next dataset of the plurality of datasets for presentation, and at least one refresh meta-tag containing a timing value.
